(19) United States
(12) Patent Application Publication
(10) Pub. No.: US 2008/0210071 A1
(43) Pub. Date: Sep. 4, 2008

(54) Anvil Wheel Comprising a Mounted Band

(76) Inventors: Dominique Font, Saint Baldoph (FR); Christophe Naulet, Chambery (FR); Jerome Vollet, Vimines (FR); Michel Oudart, Chambery (FR)

Correspondence Address: OWENS CORNING, 2790 COLUMBUS ROAD, GRANVILLE, OH, 43023, US

(21) Appl. No.: 11/817,912

(22) PCT Filed: Mar. 1, 2006
(86) PCT No.: PCT/FR2006/050181

§ 371 Date: Oct. 29, 2007

(30) Foreign Application Priority Data
Mar. 9, 2005 (FR) 0550619

(51) Int. Cl. B26D 1/01

(52) U.S. Cl. 83/347; 83/321

(57) ABSTRACT

An anvil wheel including a rim and an applied peripheral bandage. The rim includes at least two sides, which clamp the applied bandage and trap the applied bandage, each of the sides including on its lateral face at least one retention area configured to counteract expansion of the applied bandage.

The present invention relates to the field of the manufacture of cut yarns of high performance material, or yarns for technical use, particularly glass yarns, and it relates more specifically to a method for facilitating the use of a removable elastomeric bandage on the cutting machine.

There are numerous known devices for carrying out these manufacturing processes. These systems generally comprise at least one spinning machine from which the glass yarns are drawn and led into a cutting device, usually consisting of a “cutting wheel” equipped with a plurality of blades whose relative spacing contributes to the cutting of the fiber to the desired length, and a counter-wheel for cutting off, called the “anvil wheel”, usually consisting of an elastomeric bandage overmolded or applied onto a removable rim fixed to the cutting machine. The continuous cutting of the fiber is achieved by the high-speed rotation of this wheel assembly and the pressing of the cutting wheel onto the anvil wheel by a suitable tightening means.

Clearly, therefore, the quality of the fiber cut, particularly its volume density and its dynamic integrity, is directly related to the capacity of the materials present (the blades and the elastomeric counter-wheel) to preserve their characteristics (maintenance of the cutting parameters of the blades, resistant to wear by abrasion and to the notching of the anvil wheel).

To preserve optimal quality in the production of cut fibers, the operator has to change the wheel assembly relatively frequently. Usually, this changing operation consists in stopping production to remove the two wheels and replace with two new ones.

The maintenance of these wheels is not easy: their considerable weight (frequently in the range from 20 to 40 kg) makes the operation laborious, especially when repeated two to three times daily.

During a maintenance operation on an anvil wheel, the operator uncouples the anvil wheel from the drive hub projecting from the cutting machine, by removing a plurality of fixing devices (generally tightening screws fitted in a star formation around the axis of rotation).

The operator then proceeds to fit a new anvil wheel, by placing the guide surfaces of the rim and the drive shaft opposite each other. Generally, the guide surfaces consist of cylindrical, or possibly conical, bearing surfaces. When the mechanical connection between the rim and the hub has been made, the assembly is secured with the aid of fixing means (screws, studs or the like).

The principal drawbacks of this maintenance operation are found not only in the laboriousness of the task, due to the considerable weight to be handled, but above all in the difficulty of forming a coaxial mounting between the respective guide surfaces of the rim and the hub which limits the phenomena of unbalance and vibration when the parts are rotated, these phenomena being manifested in incorrect cuts and poor quality.

In order to limit the frequency of the maintenance operations, a first solution consists in making the cutting wheel and anvil wheel oversize. Clearly, in spite of the reduced frequency, the maintenance operation continues to be necessary, with all its problems.

A second solution consists in limiting the weights of the parts to be changed. Thus, anvil wheels with applied bandages have been developed. An example of this technology is illustrated by the application US2003/0037647 which describes an applied bandage principle consisting in immobilizing an elastomeric bandage on a rim having segments which are expandable by means of a compressed fluid or by mechanical means.

The problem inherent in this technical solution lies in the possibility of rupture or breakage of the means intended to fasten the elastomeric bandage to the peripheral surface of the rim. The bandage suddenly flies off the rotating rim, causing a risk of injury to the operator located in the immediate vicinity of the cutting machine. It can also be pointed out that the solution also adds radial stresses to the bandage which are added to those due to centrifugal force, and also that this assembly can generate unbalance (vibration), since it is more difficult to obtain good coaxiality of the bandage because of the large number of centering elements and the principle of expansion by inflatable jacks providing flexibility in relation to the wheel contact pressure forces.

Regardless of the solution adopted, it is necessary to center the applied bandage with respect to the peripheral surface of the rim in order to avoid the appearance of vibratory phenomena having a negative effect on the quality of cutting. To achieve this, the operation is not carried out in situ, and the operators replace the anvil wheel with a new reconditioned one during a maintenance operation. It is therefore necessary to invest in and store a large number of steel rims to allow for the number and frequency of the maintenance operations.

The object of the present invention is therefore to overcome the drawbacks of the prior art by proposing an improved anvil wheel with an applied bandage.

For this purpose, the anvil wheel, comprising a rim and an applied peripheral bandage, is characterized in that the rim comprises at least two sides, which clamp the applied bandage and trap it, each of said sides comprising on its lateral face at least one retention area adapted to counteract the expansion of the applied bandage.

Due to the presence of retention areas in several parts (one of which acts on a tenon-like part of the bandage for clamping in the area of the bandage which is distinguished from that which is already stressed by the pressure forces of the two wheels), thus making it unnecessary to add supplementary stresses on the bandage, in such a way as to obtain a compression of the bandage which tends to oppose the effects of centrifugal force when the anvil wheel is put into rotation.

In preferred embodiments of the invention, any one and/or other of the following arrangements can also be used if required:
the sides delimit a first retention area adapted to create clamping stresses in the applied bandage, and on the other hand a second retention area adapted to contribute to an absorption of the forces when the wheel with the applied bandage has been put into rotation,
the first retention area provides, on the one hand, the restraint of a heel part of the applied bandage, in order to enable the torque to be transmitted without the slipping of the rim and the applied bandage with respect to each other, and, on the other hand, the centering, due to the presence of the inclined walls between the applied bandage and the rim,
the applied bandage comprises relief parts on its lateral faces, for receiving the retention areas having a complementary profile located on the sides,
the dimensions of the applied bandage in the clamping area are greater than the complementary dimensions formed when the two sides are brought toward the bandage,
one of the sides consists of a plurality of parts hinged with respect to the other side,
the hinged parts of the side execute a movement in the manner of a book,
the applied bandage is made from a single ring piece and has relief areas on each of its sides adapted to receive at least one retention area belonging to each of the rim sides,
the ring includes an area forming a heel for use in clamping and centering between the sides and a working area to be brought into contact with a cutting wheel.

Other characteristics and advantages of the invention will be made clear by the following description of a number of embodiments thereof, provided by way of example and without restrictive intent.

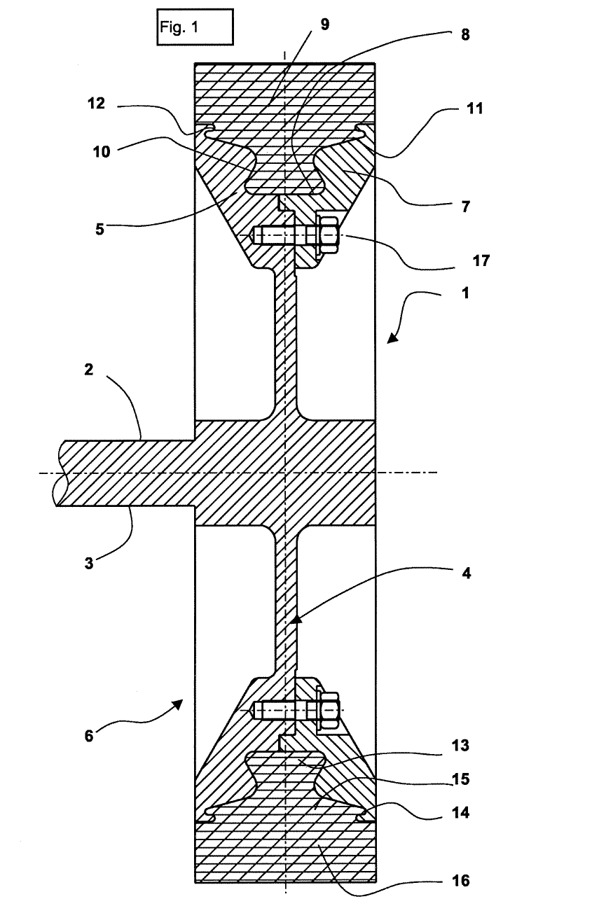

FIG. 1 is a sectional exploded view of an anvil wheel according to a first embodiment of the invention,

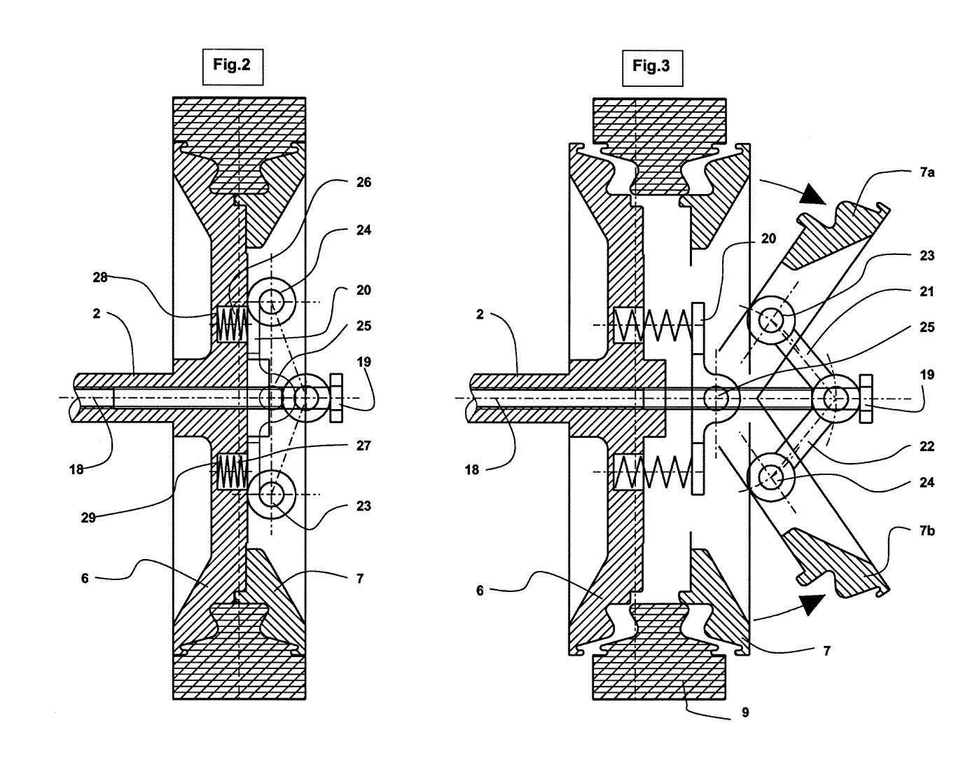

FIGS. 2 and 3 are sectional views of a second embodiment of the invention, the sides being respectively brought together or separated from each other.

In a preferred embodiment of an anvil wheel 1 according to the invention shown in FIG. 1, the wheel includes a central hub 2, particularly a steel hub, made by a sequence of conventional machining operations from a rough part made by casting for example, this hub 2 being provided with a cylindrical bearing surface 3 enabling it to be mounted on a shaft projecting from a cutting machine (not shown in the figure).

This hub 2 is also provided with a central web 4 connecting it to a peripheral ring part 5. The assembly formed by the hub 2, the central web 4 and the ring 5 forms a first side 6. A second side 7, having a generally similar shape to the previous one, is fitted onto this first side, so as to form, when the first and second sides 6 and 7 are juxtaposed with each other, a rim, particularly a steel or aluminum rim.

As shown in FIG. 1, each of the peripheral parts of the first and second sides form, when juxtaposed, a V-shaped area 8 adapted to clamp and trap a part of complementary shape belonging to an applied bandage 9, also shown in this FIG. 1.

To help retain the applied bandage 9, the sides are provided, on their inward-facing V-shaped inclined walls, with a plurality of relief areas forming retention areas 10 and 12.

Thus a first retention area 10, of substantially trapezoidal shape with a dovetail profile, is formed by bringing together the two sides 6 and 7 in the proximal part of the V, and this traps a heel part 13 of the applied bandage 9, this heel part 13 having a shape complementary to that of the first retention area 10.

This first retention area 10 provides, on the one hand, the restraint of the heel 13 to enable the torque to be transmitted without the slipping of the rim and the applied bandage 9 with respect to each other, and, on the other hand, retention in opposition to the centrifugal forces acting on the bandage, due to the presence of the inclined walls of the V between the applied bandage 9 and the rim.

The conical area 11 centers the bandage 9 coaxially with respect to the sides 6 and 7.

A second retention area 12 is formed in the distal part of the V, in the inward facing inclined walls, and takes the form of a bead (or flange) 14. These beads 14 clamp a median area 15 of the applied bandage 9, and contribute to the absorption of the forces that arise when the wheel with the applied bandage has been put into rotation, which the centrifugal force could cause by a phenomenon of flow of the plastics material forming the applied bandage 9 in the area concerned.

As shown in FIG. 1, the applied bandage 9 also includes a working area 16 which has a substantially rectangular cross section and which forms a ring. This working area 16 is not subjected to the clamping stresses but is subjected to compressive stresses due to the cutting forces originating from the cutting wheel.

In the embodiment of FIG. 1, the two sides 6 and 7 are fixed together by a plurality of studs 17, uniformly distributed along a diameter, these studs being screwed by any appropriate means.

FIGS. 2 and 3 show a second embodiment of the anvil wheel proposed by the invention.

This embodiment differs from that shown in FIG. 1 in that one of the sides 7 is hinged with respect to the central hub 2 which is fixed to the other side 6. This solution is particularly suitable when the anvil wheel has large overall dimensions.

As shown in FIGS. 2 and 3, it is possible to remove the applied bandage 9, which is identical to that shown in FIG. 1, without any need to remove the side 7, which remains fixed to the cutting machine.

FIG. 2 shows the two sides 6 and 7 in the position in which they are brought together and clamped on the applied bandage 9. For this purpose, the first side 6, which is the side fixed to a shaft of the cutting machine, is provided centrally with a bore 18 which may be tapped. This bore 18 interacts with a threaded rod 19 on which is applied a plate 20 which is movable by translation with respect to the rod 19 and which supports links 21, 22 hinged at each of their free ends on the one hand to the rod 19 and on the other hand to hinge points 23 and 24 fixed to the second side 7.

As shown in FIG. 3, the second side is made in a number of parts 7a, 7b, hinged about a central hinge 25 positioned on the plate 20.

The translation of the rod 19 inside the bore 18 causes:
a rotary movement of the half-sides 7a and 7b about the hinge 25, the links 21 and 22 assisting this movement of the half-sides 7a and 7b in the manner of a book.
a detachment of the plate 20 by means of the resilient members 26 and 27 (such as springs) housed in the cavities 28 and 29 formed in the first side and in contact with one of the faces of the plate 20.

In FIG. 3, the half-sides 7a and 7b are folded back while remaining fixed to the first side, and the applied bandage can then be removed without the removal of the rim of the anvil wheel from the shaft fixed to the cutting machine.

In FIG. 2, the rod 19 is screwed in, and the half-sides 7a and 7b together with the side 6 clamp the applied bandage as shown in FIG. 1. In order to improve further the interaction between the two sides 6, 7a and 7b, in a variant it is possible to add tightening members similar to the members 17 shown in FIG. 1.

In order to improve further the phenomenon of centering and trapping between the sides and the applied bandage, to limit or even eliminate any risk of relative rotary movement (slipping) between these parts, the inclined walls formed on the sides are made to have an aperture angle α greater than the angle β of the hollow area with a complementary profile formed in the side of the applied bandage.

Additionally, the dimensions of the applied bandage 9 in the clamping area are greater (by approximately several tenths of a millimeter) than the complementary dimensions formed by bringing the two sides 6 and 7 together onto the bandage 9.

When the sides are tightened on the central hub, thus gripping in a “pincer movement” the sides of the applied bandage, the bandage is immobilized with respect to rotation, without slipping.

This assembly is particularly effective. This is because it makes it possible to counteract the effects of centrifugal force on the bandage when the anvil wheel is put into rotation on the cutting machine.

The walls of the retention areas prevent the natural expansion of the applied bandage which can be subjected to a centrifugal acceleration of the order of 250 g.

It should be noted that this applied bandage not only retains its dimensional integrity in rapid rotation, but also enables a minimum tractive torque of at least 15 kg·m to be transmitted, while being subjected to a compressive stress by the cutting wheel at a maximum frequency of 25 Hz.

In a preferred embodiment of the applied bandage suitable for being trapped by gripping by means of the sides, the bandage is made from plastics material of a type such as a polyurethane elastomer produced by the cross-linking of a diisocyanate+glycol system. For example, it is possible to use a toluene diisocyanate (TDI), a diphenylmethane diisocyanate (MDI), or a nitro diisocyanate (NDI) in association with either a polyester or a polyether. The hardnesses used range from 80 to 95 ShA, and this bandage is formed by molding. It is made in one piece in ring form and each of its sides has relief areas adapted to receive the retention areas projecting from the sides.

It is clear from the preceding description that the applied bandage can be changed easily without any need to remove the anvil wheel from the cutting machine. It is simply necessary to slacken the fixing members connecting the sides to the central hub until the sides can be separated from each other by a sufficient distance to enable the retention areas on the sides to be released from those of complementary shape on the sides of the applied bandage.

This design makes it possible to produce large-diameter anvil wheels, the limitation imposed by the increase in weight ceases to be an impediment and the handling operations during maintenance are facilitated and can be carried out by a single operator.

This anvil wheel is intended for use on a cutting machine intended for the manufacture of cut yarns for technical use, particularly yarns of thermoplastic material and notably glass yarns, said machine comprising a three-dimensional frame having three or more sides, and at least one cutting assembly fixed to one of the sides of said frame, said cutting assembly being provided with said anvil wheel and with a cutting wheel.

1-10. (canceled)

11. An anvil wheel, comprising:
a rim; and
an applied peripheral bandage,
wherein the rim comprises at least two sides, which clamp the applied bandage and trap the applied bandage, each of the sides comprising on its lateral face at least one retention area configured to counteract expansion of the applied bandage.

12. The anvil wheel as claimed in claim 11, wherein the sides delimit a first retention area configured to create clamping stresses in the applied bandage and a second retention area configured to contribute to an absorption of forces when the wheel with the applied bandage has been put into rotation.

13. The anvil wheel as claimed in claim 12, wherein the first retention area provides restraint of a heel part of the applied bandage, to enable torque to be transmitted without slipping of the rim and the applied bandage with respect to each other, and provides centering, due to presence of inclined walls between the applied bandage and the rim.

14. The anvil wheel as claimed in claim 11, wherein the applied bandage comprises relief parts on its lateral faces, for receiving the retention areas with complementary profiles located on the sides.

15. The anvil wheel as claimed in claim 11, wherein dimensions of the applied bandage in the clamping area are greater than complementary dimensions formed when the two sides are brought together onto the bandage.

16. The anvil wheel as claimed in claim 11, wherein one of the sides includes a plurality of parts hinged with respect to the other side.

17. The anvil wheel as claimed in claim 16, wherein the hinged parts of the side execute a movement in a manner of a book.

18. An applied bandage for the anvil wheel as claimed in claim 11, made in one piece in a form of a ring and having relief areas on each of its sides configured to receive at least one retention area belonging to each of the sides.

19. An applied bandage for the anvil wheel as claimed in claim 11, wherein the ring includes an area forming a heel for clamping and forming cones for centering between the sides, and a working area to be brought into contact with a cutting wheel.

20. A cutting machine for manufacture of cut yarn for technical use, or yarn of thermoplastic material, or glass yarn, the machine comprising:
a three-dimensional frame having three or more sides; and
at least one cutting assembly fixed to one of the sides of the frame,
the cutting assembly including a cutting wheel and an anvil wheel as claimed in claim 11.
